(19) United States
(12) Patent Application Publication
(10) Pub. No.: US 2025/0319645 A1
(43) Pub. Date: Oct. 16, 2025

(54) BLOW MOLDING DEVICE

(71) Applicant: HNX CO., LTD., Seoul (KR)

(72) Inventors: Yongguk OH, Goyang-si (KR); Bumsug PARK, Gimhae-si (KR); Taejeong NOH, Changwon-si (KR)

(21) Appl. No.: 19/251,611

(22) Filed: Jun. 26, 2025

Related U.S. Application Data
(63) Continuation of application No. PCT/KR2022/021751, filed on Dec. 30, 2022.

(51) Int. Cl. B29C 49/48; B29C 49/56; B29C 49/78

(52) U.S. Cl. CPC B29C 49/482; B29C 49/56; B29C 49/78

(57) ABSTRACT

Disclosure is a blow molding device for molding a molded article including a cylindrical main body and a shaft protrusion protruding and extending from the main body along an axis direction includes: a pair of mold units configured to move close to and away from each other in a transverse direction with respect to a material supplied downwardly, and coupled to each other to form a main body molding cavity and a shaft protrusion molding cavity for respectively molding the main body and the shaft protrusion; a mold unit actuator configured to drive the mold units to move close to and away from each other; a blower configured to inject molding air into the main body molding cavity; a sliding jig installed to slide in the axis direction through an opening communicating with the shaft protruding molding cavity of the mold unit, and including a pressing surface on one end thereof; and a jig actuator configured to drive the sliding jig so that the pressing surface of the sliding jig can press downwardly the material filled in the shaft protrusion molding cavity. Therefore, the material filled in the shaft protrusion molding cavity is pushed to form the protrusion in the region of the material of the main body corresponding to the shaft protrusion, and thus the material expands by the injection of the molding air, thereby reinforcing the parting line around the shaft protrusion, and forming no groove at the bottom of the axial protrusion. Accordingly, the durability and safety of the molded article as well as the ease and efficiency of the reinforcement are improved.

### REFERENCE TO RELATED APPLICATIONS

This is a continuation of International Patent Application PCT/KR2022/021751 filed on Dec. 30, 2022, the entire contents of which are incorporated herein by reference.

### FIELD OF THE INVENTION

The disclosure relates to a blow molding device for manufacturing a molded article with a main body and a shaft protrusion.

### BACKGROUND OF THE INVENTION

A molded article manufactured by blow molding undergoes a winding operation to be improved in durability and safety. For example, the winding operation is performed in such a manner that a shaft protrusion of the molded article manufactured by coupling mold units is hung on a rotating device and the outer circumference of a main body of the molded article is then wound with reinforcing materials such as fiber reinforced plastics (FRP) while rotating the shaft protrusion. By performing this winding operation, the overall strength of the molded article is improved, and the strength of vulnerable regions such as a parting line is also reinforced.

However, the winding operation is not performed on the parting line around the shaft protrusion due to the environments of the winding operation and the shapes of the molded article, thereby causing a decrease in strength along the parting line around the shaft protrusion. In addition, a groove is formed at the lower end of the shaft protrusion in a blow molding process, but there is no proper way to prevent a decrease in strength due to the groove.

Accordingly, there is an increasing demand for a method of reinforcing the regions of the molded article where the winding operation is difficult to perform, during the blow molding process, to improve the ease and efficiency of the reinforcement as well as the durability and stability of the molded article.

### SUMMARY OF THE INVENTION

An aspect of the disclosure is to provide a blow molding device that can reinforce regions of a molded article where a winding operation is difficult to perform, during a blow molding process, thereby improving the durability and stability of the molded article as well as the ease and efficiency of the reinforcement.

According to an embodiment of the disclosure, a blow molding device for molding a molded article including a cylindrical main body and a shaft protrusion protruding and extending from the main body along an axis direction includes: a pair of mold units configured to move close to and away from each other in a transverse direction with respect to a material supplied downwardly, and coupled to each other to form a main body molding cavity and a shaft protrusion molding cavity for respectively molding the main body and the shaft protrusion; a mold unit actuator configured to drive the mold units to move close to and away from each other; a blower configured to inject molding air into the main body molding cavity; a sliding jig installed to slide in the axis direction through an opening communicating with the shaft protruding molding cavity of the mold unit, and including a pressing surface on one end thereof; and a jig actuator configured to drive the sliding jig so that the pressing surface of the sliding jig can press downwardly the material filled in the shaft protrusion molding cavity.

Therefore, the material filled in the shaft protrusion molding cavity is pushed to form the protrusion in the region of the material of the main body corresponding to the shaft protrusion, and thus the material expands by the injection of the molding air, thereby reinforcing the parting line around the shaft protrusion, and forming no groove at the bottom of the axial protrusion. Accordingly, the durability and safety of the molded article as well as the ease and efficiency of the reinforcement are improved.

The blow molding jig may further include a controller configured to control the mold unit actuator, the blower and the jig actuator, wherein the controller controls the mold unit actuator, the blower and the jig actuator so that the sliding jig can press downwardly the material filled in the shaft protrusion molding cavity, and additionally press downwardly the downwardly pressed material after the injection of the molding air.

Thus, the region around the shaft protrusion is reinforced before and after the injection of the molding air, and the formation of a groove at the lower end of the shaft protrusion is prevented.

The blow molding jig may further include a controller configured to control the mold unit actuator, the blower and the jig actuator, wherein the controller controls the mold unit actuator, the blower and the jig actuator so that the sliding jig can press downwardly the material filled in the shaft protrusion molding cavity to form a protrusion protruding inwardly to a predetermined first height along the axis direction into a region of the material of the main body corresponding to the shaft protrusion, and the first height of the protrusion reduced by the injection of the molding air can become a second height lower than the first height.

Thus, the region around the shaft protrusion is reinforced before the injection of the molding air, and the formation of a groove at the lower end of the shaft protrusion is prevented.

According to the disclosure, there is provided a blow molding device capable of reinforcing regions of a molded article where a winding operation is difficult to perform, during a blow molding process, thereby improving the durability and stability of the molded article as well as the ease and efficiency of the reinforcement.

### BRIEF DESCRIPTION OF THE DRAWINGS

FIG. 1 illustrates an example of a state in which a pair of mold units are spaced apart from each other in a blow molding device according to an embodiment of the disclosure.

FIG. 2 illustrates an example of a state in which the pair of mold units shown in FIG. 1 are brought close to each other and coupled.

FIG. 3 illustrates an example of primary pressing based on a sliding jig shown in FIG. 1.

FIG. 4 illustrates an example of injecting molding air in the state shown in FIG. 3.

FIG. 5 illustrates an example of secondary pressing based on the sliding jig in the state shown in FIG. 4.

### DETAILED DESCRIPTION OF THE INVENTION

Hereinafter, exemplary embodiments of the disclosure will be described in detail with reference to the accompanying drawings. The exemplary embodiments are to make description detailed enough for a person having ordinary knowledge in the art, to which the disclosure pertains, to easily implement the disclosure, but are not intended to limit the technical spirit and scope of the disclosure.

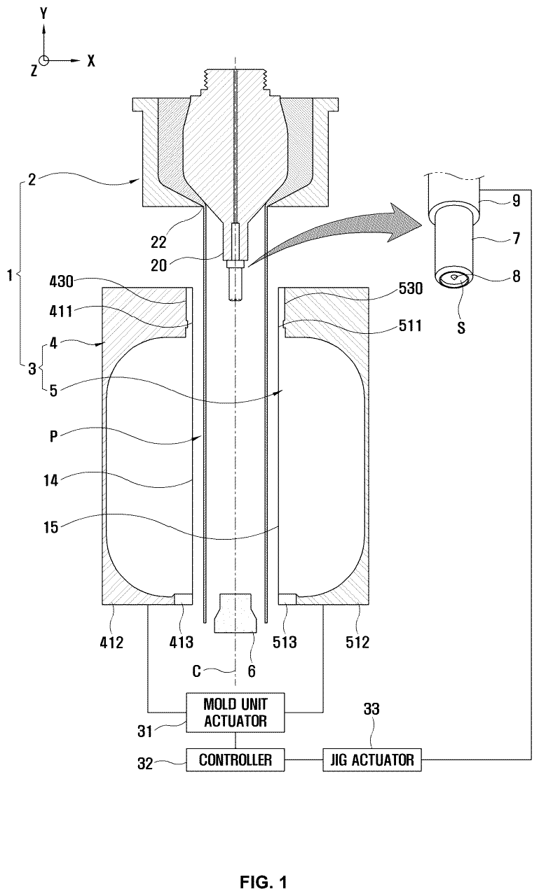

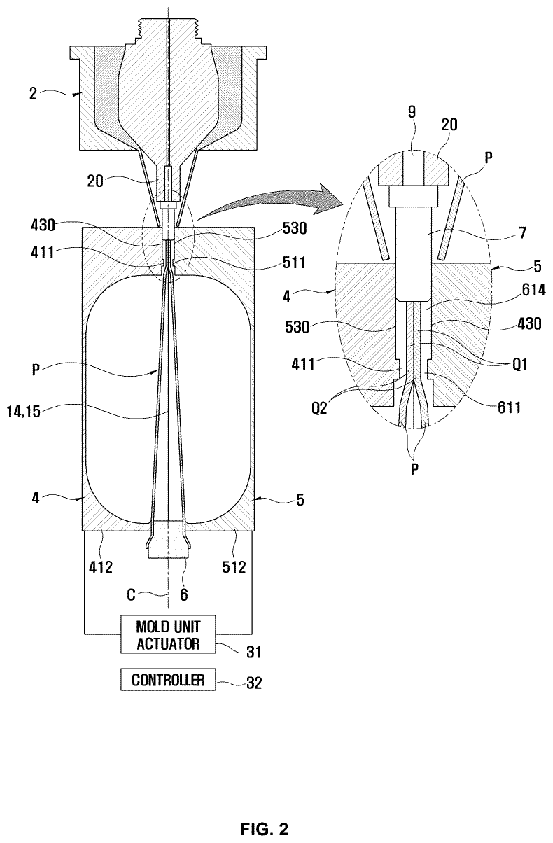

FIG. 1 illustrates an example of a state in which a pair of mold units 3 are spaced apart from each other in a blow molding device 1 according to an embodiment of the disclosure, and FIG. 2 illustrates an example of a state in which the pair of mold units 3 shown in FIG. 1 are brought close to each other and coupled.

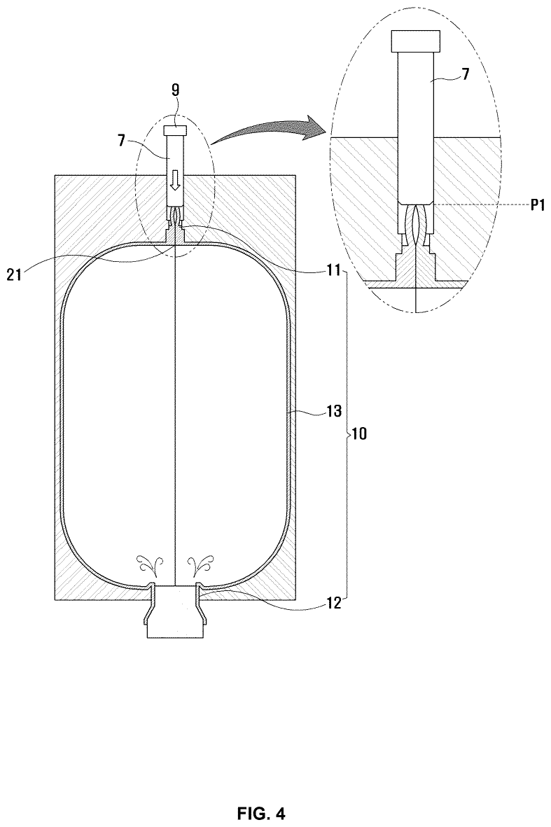

As illustrated in FIG. 1, the blow molding device 1 molds a molded article 10 (see FIG. 4) through the pair of mold units 3. The molded article 10 may be used as a gas container or the like that fills high-pressure gas therein. The molded article 10 includes a cylindrical main body 13 (see FIG. 4), and a shaft protrusion 11 (see FIG. 4) protruding and extending from the main body 13 along an Y-axis direction, i.e., the direction of an axial line C.

The shaft protrusion 11 is molded for a winding operation to enhance the durability, etc. of the molded article 10 after the molded article 10 is manufactured. For example, a reinforcing material such as fiber reinforced plastics (FRP) may be wound around the outer surface of the main body 13 of the molded article 10 by rotating the shaft protrusion 11 coupled to the shaft of a rotating device. By performing this winding operation, the molded article 10 may be improved in overall strength.

The mold unit 3 to be described below includes a first mold unit 4 and a second mold unit 5 which face each other. The first mold unit 4 has a first parting surface 14, and the second mold unit 5 has a second parting surface 15 facing the first parting surface 14. Although the first mold unit 4 and the second mold unit 5 are coupled, a predetermined gap exists between the first parting surface 14 and the second parting surface 15, thereby forming a parting line in the molded article 10 along this gap. The parting line has lower strength than other regions, and is thus required to be reinforced by the foregoing winding operation. Of course, in addition to the parting line, regions where a reinforcing material is wound may be improved overall in strength.

The first mold unit 4 and the second mold unit 5 are arranged to move close to or away from each other on both sides in the X-axis direction with respect to a material P supplied downwardly. The blow molding device 1 has a mold unit actuator 31 that drives the first mold unit 4 and the second mold unit 5 to move close to or away from each other. The mold unit actuator 31 may be implemented using a hydraulic actuator that drives the first mold unit 4 and the second mold unit 5 hydraulically, a motor that generates driving force based on electricity, or a device based on combination thereof.

The blow molding device 1 may further include a material supply unit 2 that supplies the material P. The material supply unit 2 may be provided above the mold unit 3 or the shaft protrusion 11, and supply the material P downwardly between the first mold unit 4 and the second mold unit 5 being spaced apart from each other.

The material supply unit 2 may sequentially or simultaneously perform an operation of heating a raw material of the material P, and an operation of extruding the molten material P, thereby supplying the material P downwardly between the first mold unit 4 and the second mold unit 5. The molten material P may be supplied in a cylindrical shape. The material supply unit 2 may include an extrusion opening 22 having a predetermined diameter in the X-axis direction to extrude the cylindrical material P downwardly. The material P may be implemented using a synthetic resin, but is not limited thereto.

The first mold unit 4 and the second mold unit 5 approach each other in the X-axis direction when the material P is sufficiently supplied downwardly, thereby compressing the material P. The first mold unit 4 and the second mold unit 5 include main body molding portions 412 and 512, and shaft protrusion molding portions 411 and 511. When the first mold unit 4 and the second mold unit 5 are coupled to each other, a main body molding cavity 612 and a shaft protrusion molding cavity 611 are formed corresponding to the main body molding portions 412 and 512 and the shaft protrusion molding portions 411 and 511, respectively.

The main body molding cavity 612 and the shaft protrusion molding cavity 611 refer to cavities for molding the main body 13 and the shaft protrusion 11 of the molded article 10, respectively. When the first mold unit 4 and the second mold unit 5 are coupled to each other, the material P provided in the shaft protrusion molding cavity 611 is compressed between the shaft protrusion molding portions 411 and 511 to mold the shaft protrusion 11. When a blower 6 to be described below injects molding air 61 into the main body molding cavity 612, the material P provided in the main body molding cavity 612 expands to mold the main body 13.

The mold unit 3 may be designed to further include a blower molding cavity. The first mold unit 4 and the second mold unit 5 include blower molding portions 413 and 513. When the first mold unit 4 and the second mold unit 5 are coupled to each other, the blower molding cavity is formed by the blower molding portions 413 and 513. The blower 6 is stably placed by the blower molding cavity.

The blower 6 injects the molding air 61 into the main body molding cavity 612 while the first mold unit 4 and the second mold unit 5 are coupled. The blower 6 may be implemented using a compressor capable of injecting the molding air 61 at a predetermined pressure or higher.

The blow molding device 1 according to this embodiment includes a sliding jig 7. The sliding jig 7 is installed to be slidable in the Y-axis direction, i.e., the direction of the shaft, through an opening 614 communicating with the shaft protrusion molding cavity 611 of the mold unit 3.

The sliding jig 7 may be designed to include a sliding body 9 that guides a sliding path. The sliding jig 7 may slide in the Y-axis direction while being partially or fully inserted in the sliding body 9. The sliding body 9 enables the sliding jig 7 to slide more stably in the Y-axis direction through the opening 614.

A pressing surface S is provided at the lower end of the sliding jig 7 in the Y-axis direction. The pressing surface S refers to a surface formed in the X-axis direction, and comes into contact with the material P filled in the shaft protrusion molding cavity 611, thereby applying a downward pressure. For example, the pressing surface S may be formed flat or curved. The pressing surface S may shape the upper surface of the shaft protrusion 11 so that the shaft protrusion 11 can be easily coupled to the rotating device during the winding operation.

The pressing surface S may be provided with a groove forming protrusion 8. The groove forming protrusion 8 serves to form a groove on the upper surface of the shaft protrusion 11 so that the shaft protrusion 11 can be easily connected to the rotating device during the winding operation like the pressing surface S.

The blow molding device 1 includes a jig actuator 33 that drives the sliding jig 7 to apply the downward pressure to the material P filled in the shaft protrusion molding cavity 611. The jig actuator 33 may be implemented using a hydraulic actuator that drives the sliding jig 7 hydraulically, a motor that generates driving force based on electricity, or a device based on combination thereof.

According to various embodiments, the sliding jig 7 may be, together with the material supply unit 2, arranged above the mold unit 3 or the shaft protrusion 11. As described above, the material supply unit 2 includes an extrusion opening 22 having a predetermined diameter to extrude the material P downwardly. The sliding body 9 may be arranged within the diameter of the extrusion opening 22. An upper portion of the sliding body 9 in the Y-axis direction may be accommodated in the material supply unit 2. The lower portion of the sliding body 9, not accommodated in the material supply unit 2, or the sliding jig 7 inserted into the sliding body 9 may be exposed to the outside.

The material P supplied downwardly should not be interfered with by the exposed lower portion of the sliding body 9 or the sliding jig 7. For example, the extrusion opening 22 and the sliding body 9 may be designed with a sufficient gap between the diameter of the extrusion opening 22 and the diameter of the sliding body 9. As another example, the sliding body 9 may be designed to decrease in diameter along the-Y-axis direction. Because the sliding jig 7 is inserted in the sliding body 9, the sliding jig 7 may be designed with a sufficient gap between the diameter of the extruded opening 22 and the diameter of the sliding jig 7, and the sliding jig 7 may also be designed to decrease in diameter along the-Y-axis direction.

According to various embodiments, the material supply unit 2 may further include a holder 20 to accommodate the upper portion of the sliding body 9. To eliminate interference between the material P supplied downwardly and the exposed lower portion of the sliding jig 7, the length of the holder 20 in the Y-axis direction may be adjusted.

The first mold unit 4 and the second mold unit 5 include a first opening forming portion 430 and a second opening forming portion 530, respectively. When the first mold unit 4 and the second mold unit 5 are coupled to each other, the first opening forming portion 430 and the second opening forming portion 530 form the opening 614 along the Y-axis direction. The sliding jig 7 slides through the opening 614. The opening 614 is connected to the shaft protrusion molding cavity 611 in the Y-axis direction.

When the sliding jig 7 slides downwardly in advance, the lower end of the sliding jig 7 may be accommodated within the opening 614 while the first mold unit 4 and the second mold unit 5 are coupled to each other. In other words, the sliding jig 7 may slide downward in advance so that the lower end of the sliding jig 7 can be lower in the Y-axis direction than the upper end of the mold unit 3. However, without limitations thereto, the sliding jig 7 may be positioned above the mold unit 3 and then slide downwardly to be inserted in the opening 614 after the first mold unit 4 and the second mold unit 5 are coupled to each other. Alternatively, the sliding jig 7 may be stationarily positioned above the mold unit 3, and the first mold unit 4 and the second mold unit 5 coupled to each other may move toward the sliding jig 7, thereby allowing the sliding jig 7 to be inserted in the opening 614.

In the case where the sliding jig 7 slides downwardly in advance, the material P is filled in the opening 614 and the shaft protrusion molding cavity 611 when the first mold unit 4 and the second mold unit 5 are coupled to each other. For convenience of description, the material P filled between the lower end of the sliding jig 7 and the shaft protrusion molding cavity 611 will be referred to as a first material Q1, and the material P filled in the shaft protrusion molding cavity 611 will be referred to as a second material Q2. The second material Q2 may be the shaft protrusion 11 molded based on the coupling between the first mold unit 4 and the second mold unit 5.

According to various embodiments, the blow molding device 1 further includes a controller 32 that controls the mold unit actuator 31, the blower 6, and the jig actuator 33. The controller 32 may execute software to control at least one other component (e.g., hardware or software component) of the blow molding device 1, such as the mold unit actuator 31 connected to the controller 32, and may perform various data processing or computational operations. According to an embodiment, as at least part of the data processing or computational operations, the controller 32 may store commands or data received from other components in volatile memory, process the commands or data stored in the volatile memory, and store the resulting data in non-volatile memory. According to an embodiment, the controller 32 may include a main processor (e.g., a central processing unit or an application processor) or an auxiliary processor (e.g., a graphics processing unit, a neural processing unit (NPU), an image signal processor, a sensor hub processor, or a communication processor) that may operate independently of or together with the main processor. The auxiliary processor may be configured to use less power than the main processor or to be specialized for a designated function. The auxiliary processor may be implemented separately from or as part of the main processor.

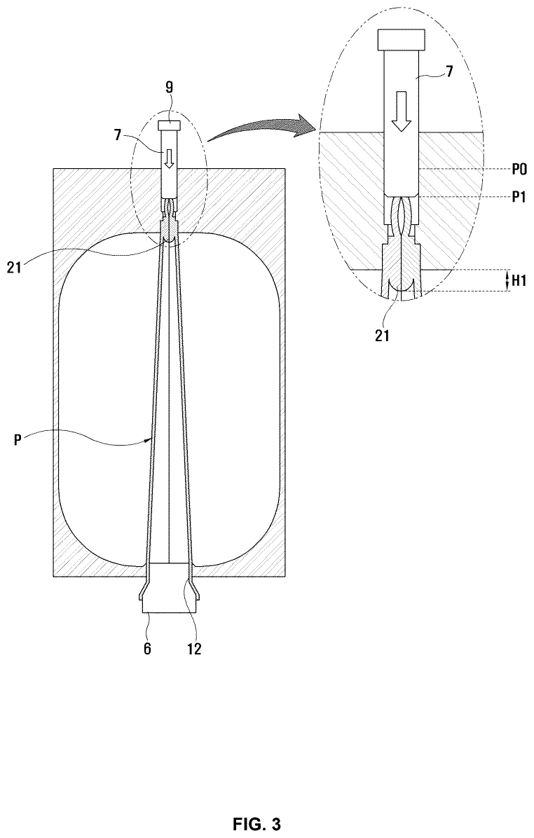

Below, a process of using the sliding jig 7 to reinforce a parting line around the shaft protrusion 11 and the lower end of the shaft protrusion 11 will be described in detail with reference to FIGS. 3 to 5.

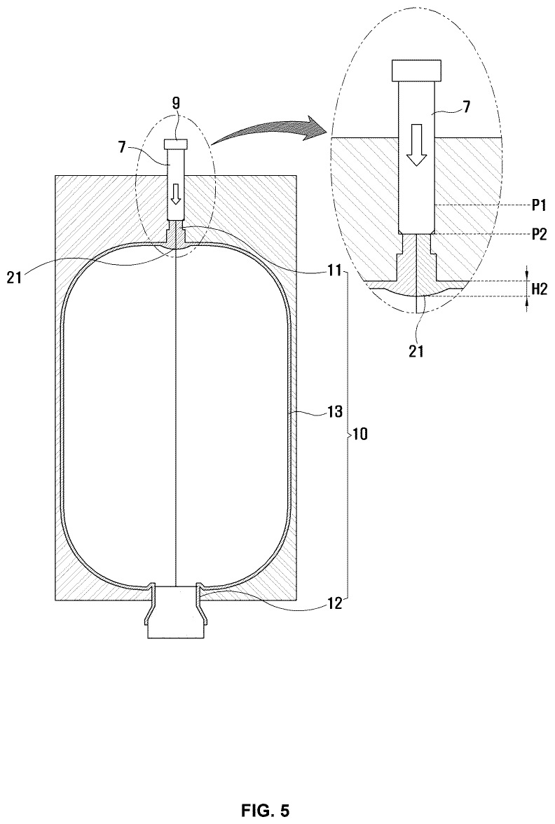

FIG. 3 illustrates an example of primary pressing based on the sliding jig 7 shown in FIG. 1, FIG. 4 illustrates an example of injecting the molding air 61 in the state shown in FIG. 3, and FIG. 5 illustrates an example of secondary pressing based on the sliding jig 7 in the state shown in FIG. 4.

It will be assumed that the lower end of the sliding jig 7 accommodated in the opening 614 is at an initial position P0 in the state that the first mold unit 4 and the second mold unit 5 are coupled to each other. The controller 32 controls the jig actuator 33 to move the sliding jig 7 sliding downwardly. Thus, the lower end of the sliding jig 7 may move from the initial position P0 to a first position P1 lower than the initial position P0, which will be referred to as a first pressing stage. The first position P1 may be closer to the shaft protrusion molding cavity 611 than the initial position P0. By the primary pressing of the sliding jig 7, the first material Q1 and the second material Q2 are pressed in succession, and a part of the second material Q2 is pushed into the main body molding cavity 612. As a result, a protrusion 21 corresponding to the shaft protrusion 11 is formed at a first height H1, protruding inwardly into the region of the material P of the main body 13. The protrusion 21 has a predetermined width on both sides in the X-axis direction and includes a mound protruding to have the first height in the-Y-axis direction.

When the molding air 61 is injected into the main body forming cavity 612 in the state that the protrusion 21 is formed, the material P expands inside the main body forming cavity 612 and the protrusion 21 spreads on both sides in the X-axis direction while reducing the first height H1 of the protrusion 21. During the injection of the molding air 61, the lower end of the sliding jig 7 maintains the first position P1.

As the first height H1 of the protrusion 21 is reduced, the material P forming the protrusion 21 expands in both directions along the X-axis direction and spreads around the shaft protrusion 11, in particular, along the parting line, thereby reinforcing the parting line. Although tension is generated while the material P expands in both directions along the X-axis direction, the protrusion 21 has a thickness margin in the-Y-axis direction, thereby causing no groove in the Y-axis direction on the lower end of the shaft protrusion 11.

According to a comparative example related to the injection of the molding air 61 without forming the protrusion 21, there is no room for the parting line around the shaft protrusion to be reinforced with the material P expanding in both directions along the X-axis direction, and the tension of the material P may cause a groove to be formed on the lower end of the shaft protrusion in the Y-axis direction. As described above, the parting line around the shaft protrusion and the material region of the main body corresponding to the shaft protrusion are difficult to reinforce with a reinforcing material due to the characteristics of a winding operation environment, and it is thus highly likely to cause an explosion depending on situations in the related comparative example as gas charged at high pressure may leak out through cracks or rupture that region.

As described above, the first height H1 of the protrusion 21 formed by the first pressing may be lowered by the injection of the molding air 61, but it is difficult for a worker to check how much the protrusion 21 has been lowered from the first height H1 within the main body molding cavity 612. Therefore, the controller 32 causes the protrusion 21 to protrude further through additional second pressing.

For example, the controller 32 controls the jig actuator 33 to move the sliding jig 7 further sliding downwardly. As a result, the lower end of the sliding jig 7 may move from the first position P1 to a second position P2 lower than the first position P1, which will be referred to as a second pressing stage. The second position P2 may be closer to the shaft protrusion molding cavity 611 than the first position P1. The first material Q1 and the second material Q2, which have already been pressed downwardly by the first pressing of the sliding jig 7, are pressed again in succession, so that a part of the second material Q2 can be pushed into the main body molding cavity 612. The protrusion 21 may be lowered than the first height H1 by the injection of the molding air 61, but may be raised to the second height H2 by the secondary pressing. The second height H2 may be lower than the first height H1.

According to the blow molding device 1 according to this embodiment, the protrusion 21 is formed by the first pressing of pushing out the second material Q2 filled in the shaft protrusion molding cavity 611. Accordingly, even when the molding air 61 is injected, the parting line around the shaft protrusion 11 is reinforced and the groove is not formed at the lower end of the shaft protrusion 11.

In addition, even after the injection of the molding air 61, the surrounding parting line is further reinforced with the height of the protrusion 21 raised by the secondary pressing, and the formation of a groove at the lower end of the shaft protrusion 11 is prevented.

Accordingly, the durability and safety of the molded article 10 are improved. Further, the ease and efficiency of the reinforcement are improved because the reinforcement is completed during the blow molding process and there is no need to perform the reinforcement for the molded article 10 separately.

According to various embodiments, the controller 32 controls the jig actuator 33 so that the second position P2 of the lower end of the sliding jig 7 due to the secondary pressing can become a point of contact with the upper end of the shaft protrusion molding cavity 611. For example, the diameter of the opening 614 may be larger than the diameter of the shaft protrusion molding cavity 611, thereby limiting the movable point of the sliding jig 7 to the upper end of the shaft protrusion molding cavity 611.

When the sliding jig 7 slides excessively beyond the upper end of the shaft protrusion molding cavity 611 corresponding to the second position P2, the shaft protrusion 11 may not be properly formed. On the other hand, when the sliding jig 7 slides insufficiently, the protrusion 21 may not be formed to a sufficient height. Here, the sufficient height may refer to a height adequate to reinforce the parting line around the shaft protrusion 11 and to fill the lower end of the shaft protrusion 11 when the material P expands due to the injection of the molding air 61.

According to various embodiments, the controller 32 may cause the lower end of the sliding jig 7 to move directly from the initial position P0 to the second position P2 and inject the molding air 61. In other words, the secondary pressing may be omitted. Although a worker cannot check the height of the protrusion 21, the additional formation of the protrusion 21 after the injection of the molding air 61 is unnecessary and may be omitted as long as the downward sliding movement of the sliding jig 7 allows the protrusion 21 to reach a sufficient height.

According to various embodiments, the controller 32 may calculate an appropriate height of the protrusion 21, in other words, the sufficient height mentioned above. The controller 32 may identify a sliding distance of the sliding jig 7 that makes the protrusion 21 be formed to the calculated height, and control the jig actuator 33 to move the sliding jig 7 by the identified distance. For example, the controller 32 identifies a first sliding distance and a second sliding distance to form the protrusion 21 to appropriate heights during the first pressing and the second pressing, and controls the jig actuator 33 to move the sliding jig 7 by the first sliding distance and the second sliding distance. Of course, when the second pressing is omitted, only the appropriate height and the first sliding distance for the first pressing may be identified, and the sliding jig 7 may be moved by the first sliding distance.

Thus, the protrusion 21 may be sufficiently formed at the lower end of the shaft protrusion 11, thereby further improving the durability and safety of the molded article 10.

In the foregoing description, the shaft protrusion 11 is formed from the upper end in the Y-axis direction, but this is merely for the convenience of description. Alternatively, the shaft protrusion 11 may be formed from the lower end in the Y-axis direction. In this case, the upper and lower positions of the mold unit 3 may be reversed, and the sliding jig 7, etc. may also be positioned at the lower end in the Y-axis direction. The blower 6 may be positioned at the upper end of the mold unit 3 in the Y-axis direction and may be accommodated in or connected to the material supply unit 2 by the holder 20. For example, the blower 6 may be positioned within the diameter of the extrusion opening 22, thereby avoiding the interference with the material P being supplied downwardly. In addition, the description of the blow molding process is omitted herein as it is redundant with the foregoing description.

Although a few exemplary embodiments of the disclosure have been described in detail, the disclosure is not limited thereto and may be implemented in various ways within the scope defined in the appended claims.

What is claimed is:

1. A blow molding device for molding a molded article comprising a cylindrical main body and a shaft protrusion protruding and extending from the main body along an axis direction, the blow molding device comprising:
a pair of mold units configured to move close to and away from each other in a transverse direction with respect to a material supplied downwardly, and coupled to each other to form a main body molding cavity and a shaft protrusion molding cavity for respectively molding the main body and the shaft protrusion;
a mold unit actuator configured to drive the mold units to move close to and away from each other;
a blower configured to inject molding air into the main body molding cavity;
a sliding jig installed to slide in the axis direction through an opening communicating with the shaft protruding molding cavity of the mold unit, and comprising a pressing surface on one end thereof; and
a jig actuator configured to drive the sliding jig so that the pressing surface of the sliding jig can press downwardly the material filled in the shaft protrusion molding cavity.

2. The blow molding jig of claim 1, further comprising a controller configured to control the mold unit actuator, the blower and the jig actuator,
wherein the controller controls the mold unit actuator, the blower and the jig actuator so that the sliding jig can press downwardly the material filled in the shaft protrusion molding cavity, and additionally press downwardly the downwardly pressed material after the injection of the molding air.

3. The blow molding jig of claim 1, further comprising a controller configured to control the mold unit actuator, the blower and the jig actuator,
wherein the controller controls the mold unit actuator, the blower and the jig actuator so that the sliding jig can press downwardly the material filled in the shaft protrusion molding cavity to form a protrusion protruding inwardly to a predetermined first height along the axis direction into a region of the material of the main body corresponding to the shaft protrusion, and the first height of the protrusion reduced by the injection of the molding air can become a second height lower than the first height.
